(19) United States
(12) Patent Application Publication
(10) Pub. No.: US 2026/0329662 A1
(43) Pub. Date: Oct. 22, 2026

(54) IN-VEHICLE SYSTEM AND CONTROL METHOD FOR IN-VEHICLE SYSTEM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(72) Inventor: Shunpei TAKAKI, Osaka-shi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(21) Appl. No.: 19/105,656

(22) PCT Filed: Jun. 12, 2023
(86) PCT No.: PCT/JP2023/021700

§ 371 Date: Feb. 21, 2025

(30) Foreign Application Priority Data
Sep. 1, 2022 (JP) 2022-138903

(51) Int. Cl. G06F 9/50; G06F 9/455

(52) U.S. Cl. CPC G06F 9/5077; G06F 9/45558; G06F 2009/4557; G06F 2009/45591

(57) ABSTRACT

An in-vehicle system including: an information processing apparatus cluster that includes a first processor and a second processor that are capable of communicating with each other, wherein the first processor and the second processor each include: computer hardware; and a virtualization platform configured to operate on the computer hardware; and a controller configured to operate one or more virtual machines on the virtualization platform of each of the first processor and the second processor, wherein the controller monitors a usage situation of hardware resources in the first processor and the second processor, and changes a configuration of the one or more virtual machines in real time according to the usage situation of the hardware resources.

### BACKGROUND

This disclosure relates to an in-vehicle control system and a control method for the in-vehicle control system. This application claims priority to Japanese Patent Application No. 2022-138903 filed on Sep. 1, 2023, the entire contents of which are hereby incorporated by reference.

Conventionally, a vehicle is provided with multiple ECUs (Electronic Control Units), which are control devices for controlling different parts of the vehicle. An ECU is essentially a computer. Thus, ECUs are capable of interrupt processing and are also able to respond appropriately in an emergency.

ECUs were originally used to control the engine. However, as equipment in vehicles has become more electronic, ECUs have come to be used in a variety of places. For example, ECUs are also in charge of processing for collecting information from various sensors provided in a vehicle. ECUs are used in determining the travel state of the vehicle, controlling brakes, controlling electrical devices, and also in lane-keeping systems, inter-vehicle distance control systems, and the like.

Meanwhile, the types of processing performed by ECUs in vehicles have also increased more than the increase in the number of ECUs installed in vehicles. Thus, there exist technologies that divide the various processing into multiple tasks which are then respectively executed in multiple ECUs. However, in the case of in-vehicle ECUs, the magnitude of the load of each task varies greatly depending on the situation. Thus, the load on the ECUs needs to be dynamically distributed.

One proposal for solving this problem is disclosed in JP 2009-070135A. The technology disclosed in JP 2009-070135A provides an ECU that executes a task with a virtual device driver for enabling an external device to be utilized transparently. Then, when the task is transferred (migrated) to another ECU, this virtual device driver is also transferred to the other ECU. This enables the external device to also be transparently utilized by the other ECU to which the task is transferred. Note that this migration is performed while the ECUs are operating. Such migrations are called “live migrations”. All migrations described herein are live migrations and will be referred to simply as “migrations” for the sake of brevity.

### SUMMARY

An in-vehicle system according to a first aspect of this disclosure is an in-vehicle system including an information processing apparatus cluster that includes a first processor and a second processor that are capable of communicating with each other, wherein the first processor and the second processor each include: computer hardware; and a virtualization platform configured to operate on the computer hardware; and a controller configured to operate one or more virtual machines on the virtualization platform of each of the first processor and the second processor, wherein the controller monitors a usage situation of hardware resources in the first processor and the second processor, and changes a configuration of the one or more virtual machines in real time according to the usage situation of the hardware resources.

The above and other objects, features, aspects and advantages of the disclosure will become apparent from the following detailed description relating to this disclosure, taken in conjunction with the attached drawings.

### BRIEF DESCRIPTION OF THE DRAWINGS

FIG. 1 is a block diagram showing an outline of the configuration of an ECU to which virtualization technology is applied.

FIG. 2 is a schematic diagram for describing an ECU cluster.

FIG. 3 is a schematic diagram for describing migration of a virtual ECU in the ECU cluster.

FIG. 4 is a block diagram showing one example of placement of a controller that controls the ECU cluster.

FIG. 5 is a block diagram showing another example of placement of the controller that controls the ECU cluster.

FIG. 6 is a schematic diagram showing one example of the contents of a host designation configuration (setting) file that is used in the embodiment.

FIG. 7 is a schematic diagram showing one example of the contents of a priority configuration file that is used in the embodiment.

FIG. 8 is a schematic diagram showing one example of the contents of an initial resource designation configuration file that is used in the embodiment.

FIG. 9 is a schematic diagram for describing migration of a virtual machine between different ECUs.

FIG. 10 is a schematic diagram for describing reduction of resource usage (expansion of available resources) in a single ECU.

FIG. 11 is a block diagram showing a hardware configuration of the in-vehicle system and the ECUs according to the disclosure.

FIG. 12 is a flowchart illustrating a control structure of a program for resource management that is executed by the controller of the in-vehicle system of the embodiment.

FIG. 13 is a flowchart showing a control structure of a computer program that realizes processing for starting virtual machines shown in FIG. 12.

FIG. 14 is a flowchart showing a control structure of a computer program that realizes processing for resource optimization shown in FIG. 12.

FIG. 15 is a flowchart showing a control structure of a computer program that realizes migration shown in FIG. 14.

FIG. 16 is a flowchart showing a control structure of a computer program that realizes resource reduction processing shown in FIG. 14.

### DETAILED DESCRIPTION OF EMBODIMENTS

### Technical Problem

Following recent developments in computer technologies, it has become possible to build a virtualization platform on a single ECU and operate multiple virtual machines using independent OSs (Operating Systems), BSW (Basic Software), and the like on this virtualization platform. That is, one or more virtual ECUs can be operated on one ECU. As a result, the large number of ECUs that are used in vehicles can be condensed into a comparatively small number of ECUs. However, even when operating multiple virtual machines on a comparatively small number of ECUs in such a manner, it is necessary to dynamically distribute the load on the ECUs.

The technology disclosed in JP 2009-070135A is load distribution at the application task level. When the technology disclosed in JP 2009-070135A is applied to an ECU on which virtual machines are operating, the load will be distributed among the plurality of virtual ECUs operating on that ECU. Such a method is not able to reduce the load on the ECU on which the virtual machines are operating. This problem is not limited to ECUs and can also similarly occur in a plurality of information processing apparatuses installed in a vehicle.

An object of this disclosure is to provide an in-vehicle system and a control method that are able to dynamically control the load on information processing apparatuses on which virtual machines are operating.

### Advantageous Effects of Disclosure

As described above, according to this disclosure, an in-vehicle system and a control method that are able to dynamically control the load on information processing apparatuses on which virtual machines are operating can be provided.

### Summary of Embodiments of Disclosure

This disclosure can be summarized as follows.
(1) An in-vehicle system according to a first aspect of this disclosure is an in-vehicle system including an information processing apparatus cluster that includes a first information processing apparatus and a second information processing apparatus capable of communicating with each other, in which the first information processing apparatus and the second information processing apparatus each include computer hardware and a virtualization platform configured to operate on the computer hardware, the in-vehicle system further includes a controller configured to operate one or more virtual machines on the virtualization platform of each of the first information processing apparatus and the second information processing apparatus, and the controller monitors a usage situation of hardware resources in the first information processing apparatus and the second information processing apparatus, and changes a configuration of the one or more virtual machines in real time, according to the usage situation of the hardware resources.

The first information processing apparatus and the second information processing apparatus are provided separately in one information processing apparatus cluster. The controller operates one or more virtual machines on each of these information processing apparatuses. The controller monitors the usage situation of the hardware resources in the first information processing apparatus and the second information processing apparatus and changes the configuration of the virtual machines in real time, according to the usage situation of the hardware resources. As a result, the controller is able to dynamically control the load on the information processing apparatuses on which the virtual machines are operating. Since this load control can be executed independently of load control in other information processing apparatus clusters, dynamic control of the load on virtual machines in an in-vehicle system can be easily performed.
(2) In (1) above, the controller may include a controller device provided independently of the first information processing apparatus and the second information processing apparatus included in the information processing apparatus cluster, and capable of communicating with the first information processing apparatus and the second information processing apparatus.

The controller device is provided independently of both the first information processing apparatus and the second information processing apparatus, and this controller device functions as the controller. As a result, the controller device is not affected by dynamic control of the load on the information processing apparatuses, thus enabling dynamic control of the load on the information processing apparatuses for execution of the virtual machines in the in-vehicle system to be stably performed.
(3) In (1) above, the controller may include a virtual controller configured to be executed on the virtualization platform of the first information processing apparatus.

The controller is realized as a virtual controller on the virtualization platform of the first information processing apparatus. Hardware for executing the controller need not be independently provided, thus enabling the cost of in-vehicle devices to be kept low, and also facilitating maintenance.
(4) In any one of (1) to (3) above, the controller may include a placement configuration recording unit configured to record placement configuration information defining a placement configuration of the one or more virtual machines, and a placement control unit configured to monitor an operation situation of the first information processing apparatus and the second information processing apparatus, determine placement of the one or more virtual machines in the information processing apparatus cluster in real time, such that the one or more virtual machines operate stably, and change the placement of the one or more virtual machines if necessary.

The placement configuration of virtual machines is provided separately from the placement control unit. When changing the placement of a virtual machine, it is only necessary to change the recorded contents of the placement configuration recording unit, and not the function of the placement control unit. As a result, the placement configuration of virtual machines can be easily changed.
(5) In (4) above, the placement configuration information may include host designation information recording a virtual machine, among the one or more virtual machines, to be operated in a specific information processing apparatus that is a host, and information designating the specific information processing apparatus that is the host, priority information designating priorities relating to the one or more virtual machines and for use when allocating the hardware resources, initial resource information designating an initial allocation of the hardware resources when starting the one or more virtual machines, or at least two of the host designation information, the priority information, and the initial resource information.

When host designation information is used, a virtual machine that needs to be operated in a specific information processing apparatus can be prevented from being moved to another information processing apparatus, for example. When priority information is used, hardware resources are preferentially allocated to virtual machines that are more important to the in-vehicle system. As a result, the in-vehicle system is able to stably provide predetermined functions. When using initial resource information, the placement of virtual machines can be quickly determined when the in-vehicle system is started. There is no need to adjust the placement of virtual machines after startup, thus enabling the time required to start the in-vehicle system to be shortened.
(6) In (4) above, the placement configuration information may include host designation information recording a virtual machine, among the one or more virtual machines, to be operated in a specific information processing apparatus that is a host, and information designating the specific information processing apparatus that is the host, and priority information designating priorities relating to the one or more virtual machines and for use when allocating the hardware resources, the priorities may include a first priority that is highest and a second priority that is lower than the first priority, and the placement control unit may include a host control unit configured to monitor the usage situation of the hardware resources in the first information processing apparatus, and, in response to tightness of the hardware resources being detected in the first information processing apparatus, select a virtual machine that is shown by the host designation information as being movable to the second information processing apparatus and whose priority is the second priority, among virtual machines being executed in the first information processing apparatus, and move the selected virtual machine to the second information processing apparatus.

The virtual machine that is moved from the first information processing apparatus to the second information processing apparatus, when tightness of hardware resources is detected in the first information processing apparatus, will be a virtual machine that is movable to the second information processing apparatus and that is assigned the second priority. The possibility of a virtual machine that is important for realizing the functions of the in-vehicle system being moved to an information processing apparatus that cannot fully exhibit the functions thereof can be removed, and the in-vehicle system is able to stably exhibit the functions required of the in-vehicle system.
(7) In (6) above, the placement control unit may further include a resource reduction unit configured to monitor the usage situation of the hardware resources in the first information processing apparatus and the second information processing apparatus, and, in response to tightness of hardware resources in the in-vehicle system being detected even after movement of a virtual machine by the host control unit, reduce allocation of the hardware resources to a virtual machine whose priority is the second priority, among virtual machines operating in the information processing apparatus in which tightness of the hardware resources is detected.

There are cases where tightness of hardware resources is detected even after a virtual machine is moved, or where tightness of hardware resources cannot be eliminated due to not being able to move a virtual machine. In such cases, allocation of hardware resources to low priority virtual machines is reduced in the information processing apparatus in which the tightness of hardware resources is detected. As a result, the amount of hardware resources available to high priority virtual machines increases, enabling the performance of the in-vehicle system to be maintained.
(8) In any one of (1) to (7) above, the in-vehicle system may include a plurality of the information processing apparatus clusters.

Even in the case where a plurality of information processing apparatus clusters are provided, dynamic distribution of the load on the information processing apparatuses relating to execution of the virtual machines in each information processing apparatus cluster can be performed independently. As a result, even if the number of virtual machines and information processing apparatuses that are used in the entire in-vehicle system increases, the functions of the in-vehicle system can be stably maintained.
(9) A control method of an in-vehicle system according to a second aspect of this disclosure is a control method of an in-vehicle system that includes an information processing apparatus cluster including a first information processing apparatus and a second information processing apparatus capable of communicating with each other, the first information processing apparatus and the second information processing apparatus each including computer hardware and a virtualization platform configured to operate on the computer hardware, the control method including a step of operating, with a computer, one or more virtual machines on the virtualization platform of each of the first information processing apparatus and the second information processing apparatus, a step of monitoring, with the computer, a usage situation of hardware resources in the first information processing apparatus and the second information processing apparatus, and a step of changing a configuration of the one or more virtual machines in real time, in response to tightness of hardware resources being detected in the first information processing apparatus.

The first information processing apparatus and the second information processing apparatus are provided separately in one information processing apparatus cluster. The computer operates one or more virtual machines on each of these information processing apparatuses. The computer monitors the usage situation of hardware resources in the first information processing apparatus and the second information processing apparatus and changes the configuration of the virtual machines in real time, according to the usage situation of the hardware resources. As a result, the computer is able to dynamically control the load on the information processing apparatuses on which the virtual machines are operating. Since this load control can be executed independently of load control in other information processing apparatus clusters, dynamic control of the load on the virtual machines in the in-vehicle system can be easily performed.

### Detailed Description of Embodiments of Disclosure

Specific examples of an in-vehicle system and a control method thereof according to an embodiment of the present disclosure will be described below with reference to the drawings. In the following description and drawings, components that are the same are given the same reference numerals. Accordingly, detailed description thereof will not be repeated. Note that the present disclosure is not limited to these illustrative examples and is indicated by the claims, and all changes that come within the meaning and range of equivalency of the claims are intended to be embraced therein. Also, any of one or more of the features of the following embodiments may be combined.

### First Embodiment

### 1. Configuration

### A. ECU

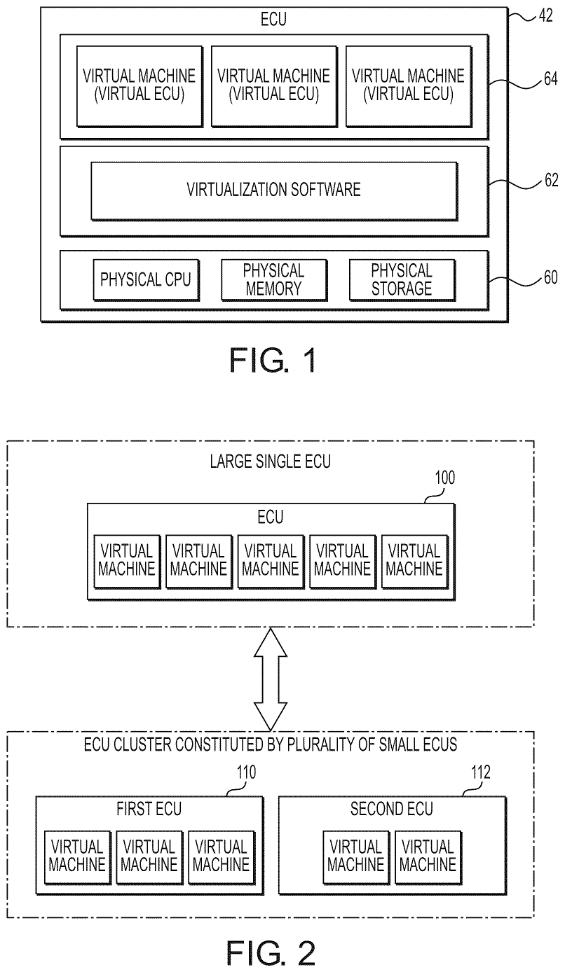

FIG. 1 shows a schematic configuration of an ECU 42 according to a first embodiment of this disclosure. Referring to FIG. 1, the ECU 42 includes a physical hardware layer 60 including computer hardware, a virtualization platform layer 62 built on the physical hardware layer 60, and a virtual machine layer 64 including one or more virtual machines (virtual ECUs) that operate on the virtualization platform layer 62. The virtualization platform layer 62 uses the hardware resource provided by the physical hardware layer 60.

The virtual ECUs all execute the same tasks as conventional ECUs. These virtual ECUs all operate in a virtual operating environment that is provided by the virtualization platform layer 62 and is the same as a conventional operating environment. Thus, the OS and applications that are executed by the virtual ECUs are the same as the OS and applications that are executed by a single conventional ECU.

### B. ECU Clusters

As shown in FIG. 1, one ECU is able to operate a plurality of virtual ECUs. However, when a plurality of virtual ECUs are operated on individual ECUs, there is a possibility that the load on a specific ECU will become excessive. The occurrence of such situations needs to be avoided.

In order to avoid such problems, in this embodiment, the concept of an ECU cluster is introduced. An ECU cluster is a group consisting of a plurality of ECUs that each operate one or more virtual ECUs. The ECU cluster defines the range of the movement destination when migrating (moving) virtual ECUs as will be described later. That is, virtual ECUs operating in an ECU within one ECU cluster can migrate to another ECU within the same ECU cluster but cannot migrate to an ECU in another ECU cluster. An ECU cluster constructed in this way is provided with a controller for balancing the load on the ECUs within the cluster or reducing the load on the ECUs, by monitoring the usage situation of resources of the ECUs within the ECU cluster. Provision of ECU clusters enables the number of ECUs and virtual ECUs managed by one controller to be comparatively reduced, and has the effect of facilitating management and enabling necessary processing to be performed quickly.

Note that it is also conceivably possible to avoid the occurrence of a situation in which the load becomes excessive by increasing the size and improving the performance of individual ECUs, without using an ECU cluster. An example based on such a concept is shown in the upper part of FIG. 2 as an ECU 100. In this example, a large number of virtual machines are operated in the ECU 100. On the other hand, an example based on the concept of an ECU cluster is shown in the lower part of FIG. 2. In the format shown in the lower part of FIG. 2, an ECU cluster is formed by a plurality of ECUs (e.g., first ECU 110/first processor and second ECU 112/second processor) that are smaller in size and have lower performance than the ECU 100 shown in the upper part. A plurality of virtual ECUs operate in each of the first ECU 110 and the second ECU 112. Although the performance of these ECUs is inferior to the ECU 100, computing resources comparable to the upper part of FIG. 2 can be provided, by employing an ECU cluster such as shown in the lower part of FIG. 2.

In an actual vehicle, however, it is desirable to employ the configuration of the lower part of FIG. 2. The reasons for this are as follows. As described above, due to the configuration of the upper part of FIG. 2, when resources in the ECU 100 are tight, virtual ECUs cannot be migrated to other ECUs. In contrast, in the configuration shown in the lower part of FIG. 2, virtual ECUs can be migrated between ECUs belonging to the same ECU cluster. Also, when products of the same standard are used as the first ECU 110 and the second ECU 112, the number of ECUs is adjustable in conjunction with the performance requirements of the vehicle. Thus, an increase in costs due to using ECUs having excessive performance can be prevented. In addition, there is also the advantage of lower procurement costs of ECUs due to mass production, and lower manufacturing costs of vehicles as a result.

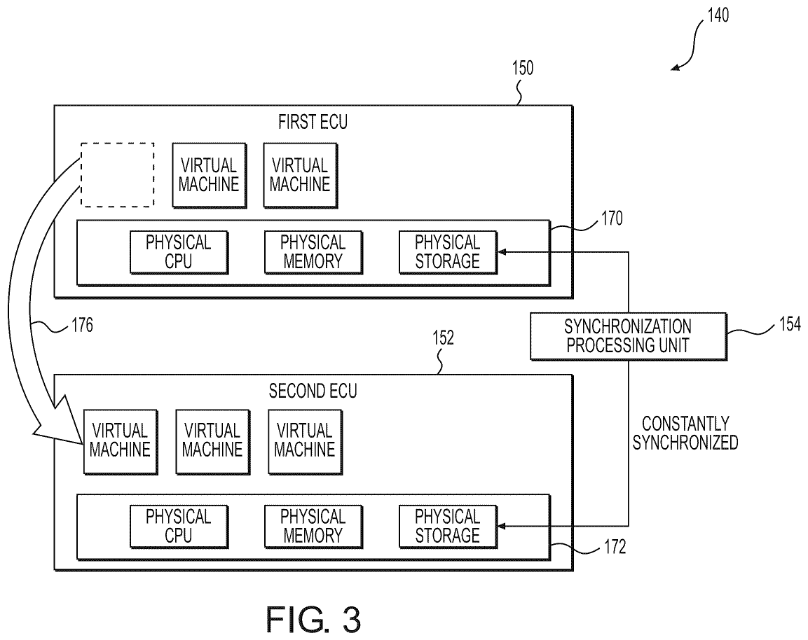

FIG. 3 describes migration in the configuration in the lower part of FIG. 2. Referring to FIG. 3, an in-vehicle ECU cluster 140 is shown as including a first ECU 150 and a second ECU 152. The first ECU 150 and a physical hardware layer 170 are capable of communicating with each other through an in-vehicle network not shown. For example, as shown at the left edge of FIG. 3, if there are resources available in the second ECU 152 when resources in the first ECU 150 are tight, migration 176 of one of the virtual ECUs operating in the first ECU 150 is performed to the second ECU 152. Migrating one of the virtual ECUs frees up resources in the first ECU 150, and stable operation of other virtual ECUs operating in the first ECU 150 can be maintained. That is, problems in the operation of the virtual ECUs due to resource tightness can be prevented.

Note that, in order to perform such migration, the state of the virtual ECU (contents of memory, virtual registers, etc.) also needs to be transferred from the first ECU 150 to the second ECU 152. In this embodiment, rather than transferring such state information at the time of migration, a synchronization processing unit 154 is provided to synchronize the storage contents of the physical hardware layer 170 of the second ECU 152 and the storage contents of a physical hardware layer 172 of the second ECU 152. Adopting this configuration enables the virtual ECUs to continue operating even when migration occurs, since the pre-migration state information is stored in the physical storage. Note that, as will be described later, there are also virtual ECUs that do not migrate, because the host ECU in which those virtual ECUs operate is designated or the resource allocation priority thereof is set to high. Such virtual ECUs do not require this synchronization processing.

In this embodiment, a controller is provided in one in-vehicle ECU cluster, in order to execute synchronization processing of state information by the synchronization processing unit 154, monitoring of the usage situation of resources of the physical hardware layers 170 and 172 in the first ECU 150 and second ECU 152, and migration.

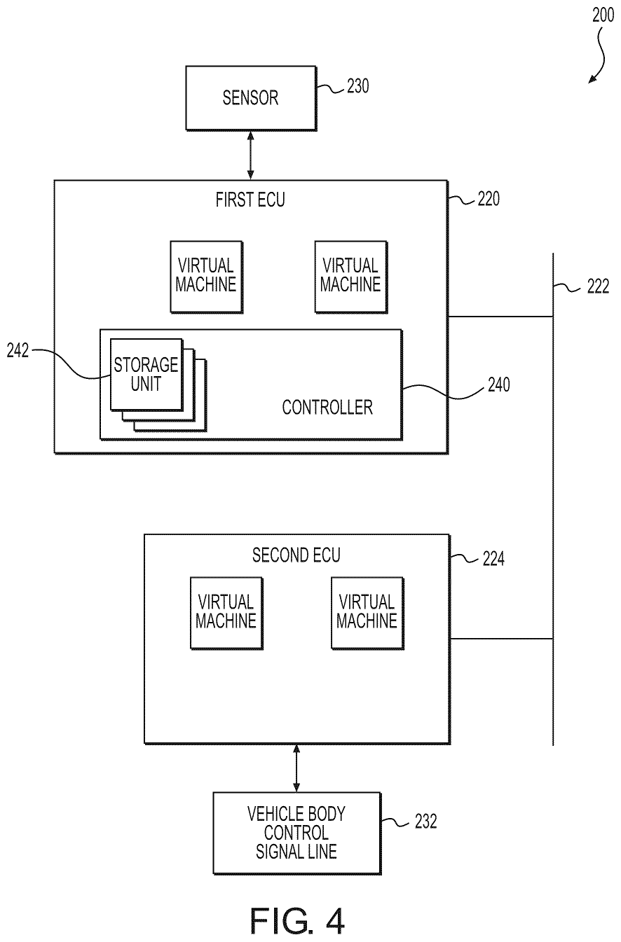

FIG. 4 shows a first example of placement of the controller. Referring to FIG. 4, this in-vehicle system 200 includes a first ECU 220 and a second ECU 224 that are capable of communicating with each other through an in-vehicle network 222. Of these, the first ECU 220 has a sensor 230 or the like, for example, connected thereto. The second ECU 224 has a different device from the first ECU 220 connected thereto, such as a vehicle body control signal line 232, for example. The first ECU 220 is provided with a controller 240 that dynamically controls the configuration of the virtual ECUs in the in-vehicle system 200. The controller 240 operates as a virtual machine, similarly to the other virtual ECUs. That is, the controller 240 can be referred to as a virtual controller.

There are certain restrictions on dynamic control of the configuration of the virtual ECUs by the controller 240. The sensor 230 or the like is connected to the first ECU 220, for example. Accordingly, the virtual ECU in which a task for processing information from the sensor 230 or the like is operating must reside in the first ECU 220 and is not able to migrate to the second ECU 224. Similarly, the second ECU 224 has the vehicle body control signal line 232 or the like connected thereto. Accordingly, the task of controlling the vehicle body must function in a virtual ECU that operates on the second ECU 224 and is not able to migrate to the first ECU 220.

The controller 240 has a storage unit 242 for storing constraint conditions relating to placement of the virtual ECUs and conditions relating to, for example, how the virtual ECUs are placed in the first ECU 220 and the second ECU 224 when the in-vehicle system 200 is started. The storage unit 242 holds such conditions in the form of a configuration file and loads these conditions when the controller 240 is started. Hereinafter, configuration will be referred to as “config”, and configuration files will be referred to as “config files”. Example contents of the config files will be described later.

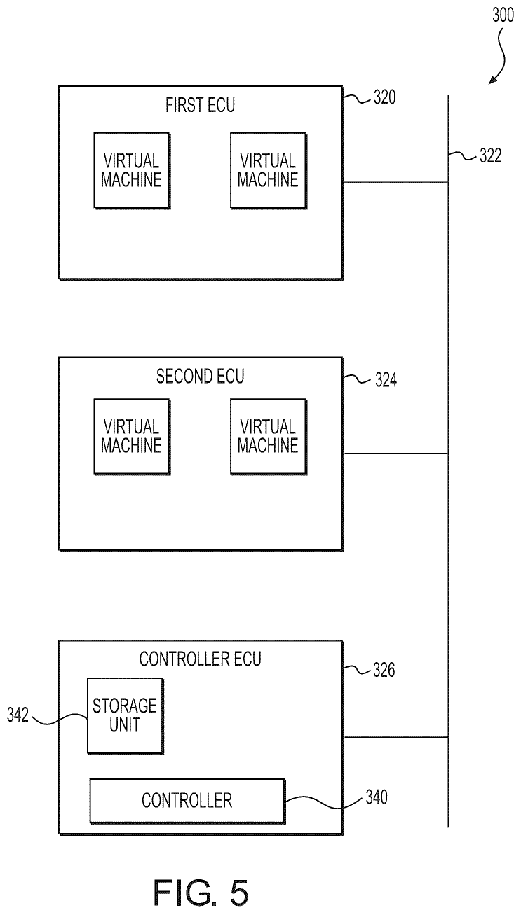

FIG. 5 shows another example of placement of the controller. Referring to FIG. 5, the in-vehicle system 300 includes an in-vehicle network 322, a first ECU 320 and a second ECU 324 that are capable of communicating with each other via an in-vehicle network 322 and are each capable of hosting one or more virtual ECUs, and a controller ECU 326 which is a controller device that is provided independently of the first ECU 320 and the second ECU 324 and is capable of communicating therewith via the in-vehicle network 322. In this example, the controller ECU 326 includes a storage unit 342 that is similar to the storage unit 242 shown in FIG. 4. A controller 340 that is realized by a program operates in the controller ECU 326. The controller ECU 326 has the storage unit 342 for storing config files. Unlike the first ECU 320 and the second ECU 324, the controller ECU 326 does not use virtualization technology. The controller ECU 326 operates as an independent ECU, similarly to a conventional ECU.

In this embodiment, the storage units 242 and 342 store three types of config files. These are a host designation config, a priority config, and an initial resource designation config.

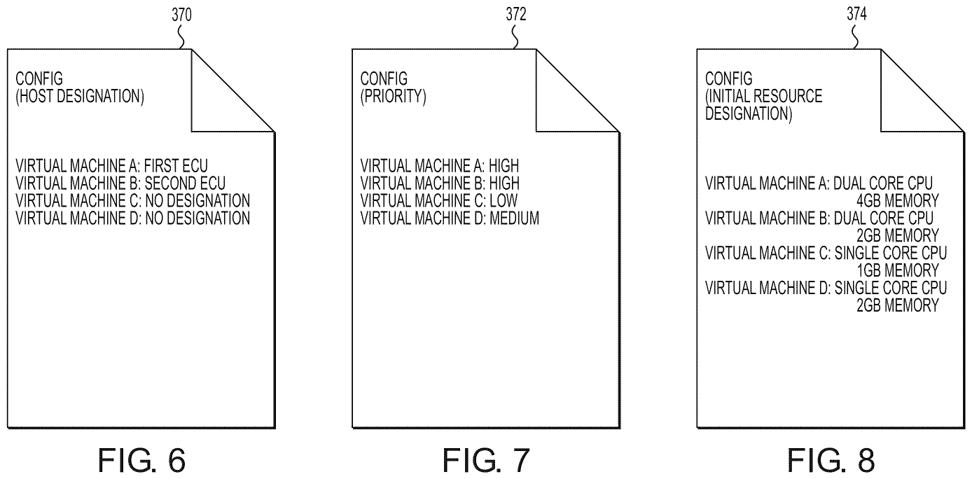

Referring to FIG. 6, the host designation config 370 lists the ECUs in which all the virtual ECUs are to operate. In the case of the in-vehicle system 200 of FIG. 4, for example, a virtual machine A (which is actually designated by an identifier of the virtual machine A) operates in the first ECU 220 and is not able to migrate to the second ECU 224. A virtual machine B operates in the second ECU 224 and is not able to migrate to the first ECU 220. No such designation of an ECU is shown for virtual machines C and D. The virtual machines C and D are operable in both the first ECU 220 and the second ECU 224 and, accordingly, are able to migrate.

Note that, in this example, the host designation config 370 contains the information “no designation” for the virtual machines C and D, but this disclosure is not limited to such a mode. For example, there may be an understanding that “no designation” is the default designation for virtual ECUs that are not listed in the host designation config 370. In this case, however, there needs to be some way of grasping all the virtual ECUs to be started. For example, a config file listing the identifiers of all the virtual ECUs may be provided separately.

An ECU can be designated by the name, identifier, or address of the ECU. A predetermined symbol or number may be associated with each ECU and the ECU may be designated by that symbol or number. A vector having elements equal to the number of ECUs may be prepared, with each element associated with an ECU, and the vector may be used to designate ECUs in which virtual ECUs are operable by setting the value of corresponding elements to “0”, for example, and to designate ECUs in which virtual ECUs are not operable by setting the value of corresponding elements to “1”, for example, or ECUs in which virtual ECUs are operable and ECUs in which virtual ECUs are not operable may be designated by viewing the array of elements of the vector as binary numbers and using the values thereof. An octal representation or a hexadecimal representation can also be used as the representation of the values in this case.

By using the host designation config 370 in this way, host ECUs in which virtual machines operate can be appropriately controlled.

FIG. 7 shows example contents of the priority config 372. Referring to FIG. 7, the priority config 372 stores the priority of each virtual ECU. In this embodiment, there are three priority levels: high, medium, and low. In the case of an in-vehicle system, the functions realized by the virtual ECUs include functions with different priorities, such as functions that are required to be highly reliable, functions that are necessary for the vehicle but are not required to be highly reliable, and functions that are preferably included but not essential for control of the vehicle. For example, functions such as traveling, turning, and stopping relate to original functions of the vehicle, and are required to be highly reliable. Among additional functions such as power window control and infotainment, functions such as those having a comparatively high priority are desirable functions for a vehicle to have and are not required to be so highly reliable. Furthermore, so-called infotainment functions such as those having a comparatively low priority are not original functions of the vehicle and are thus not essential.

As described above, allocation of resources to virtual ECUs for realizing functions that are required to be highly reliable needs to be prioritized. On the other hand, allocating resources is a low priority in the case of functions that are not essential for controlling the vehicle. The virtual ECUs correspond to these functions. Accordingly, the priority config 372 contains a priority for each virtual ECU.

Note that, in this example, there are three priority levels. However, this disclosure is not limited to such an embodiment. There are cases where two priority levels are sufficient, and there can also be cases where four or more priority levels are required.

FIG. 8 shows example contents of the initial resource designation config 374. The virtual ECUs need to be started when the in-vehicle system is started. It is desirable to optimize the placement of the virtual ECUs at the time of startup while conforming to the above constraints. The initial resource designation config 374 contains conditions for that purpose. That is, when the in-vehicle system is started, the initial allocation of resources to each virtual ECU is executed in accordance with the description in the initial resource designation config 374.

Referring to FIG. 8, in this example, the initial resource designation config 374 describes, for each virtual ECU, physical resources (number of CPU (Central Processing Unit) cores, memory size, etc.) to be allocated when the virtual ECU is started, for example. As will be described later, the controller determines the optimal placement of the virtual ECUs, with reference to the contents of the initial resource designation config 374. Note that, after the in-vehicle system is started, the placement of the virtual ECUs changes dynamically according to the usage situation of resources in the ECUs. Accordingly, in this embodiment, the initial resource designation config 374 shown in FIG. 8 is merely used to determine the placement of the virtual ECUs when the in-vehicle system is started. Of course, the initial resource designation config 374 can also be used in order to maintain the initial placement as much as possible while the resource placement is dynamically changed.

Note that, in this embodiment, the controller performs two types of processing, namely, migration and resource reduction, on the virtual ECUs after the in-vehicle system is started. These will be described below.

First, migration will be described. Migration is the transfer of a virtual ECU operating in one ECU to another ECU within the same ECU cluster. Although operation of the other virtual ECUs in the ECU cluster is not stopped at this time, operation of the virtual ECU to be migrated is stopped momentarily (about a few milliseconds). Thus, virtual ECUs that are required to be highly reliable are not to be migrated. Also, virtual ECUs whose host ECU is designated are also not able to migrate. In view of this, in this embodiment, the following restrictions are provided. By providing restrictions such as the following, low-priority virtual ECUs that are not device dependent can be actively migrated. As a result, the load placed on each ECU can be distributed, and stable operation of the virtual ECUs can be realized in each ECU.
Virtual ECU having “high” priority: not migratable
Virtual ECU having “medium” priority: migratable
Virtual ECU having “low” priority: migratable
Virtual ECU whose host is designated: not migratable
Virtual ECU whose host is not designated: migratable

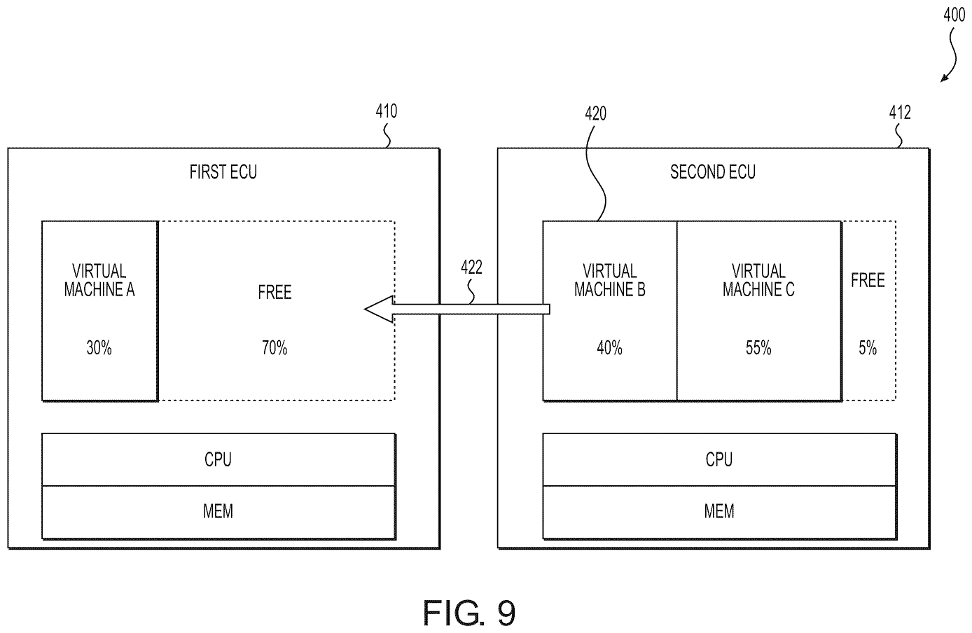

Referring to FIG. 9, an in-vehicle ECU cluster 400 is shown as including a first ECU 410 and a second ECU 412. A virtual machine A is operating in the first ECU 410. A resource occupancy rate thereof is 30%. No other virtual ECUs are operating in the first ECU 410. Accordingly, 70% of resources are free. Note that “resource occupancy rate” is a concept that combines the CPU occupancy rate and the memory occupancy rate. How the resource occupancy rate is calculated depends on the thinking of the designer.

On the other hand, a virtual machine B and a virtual machine C are operating in the second ECU 412, and the resource occupancy rates thereof are 40% and 55%, respectively. 5% of resources are free. It is assumed that the controller is programmed to determine that the resources of the ECU are tight when the amount of free resources in the ECU falls to less than or equal to a predetermined threshold value (e.g., 15%). In a state such as shown in FIG. 9, it is thus determined that resources are tight in the second ECU 412.

In the example shown in FIG. 9, both the virtual machine B and the virtual machine C are allowed to migrate, for example. In this case, the controller then determines which virtual ECU to migrate, such that the distribution of resources after migration is balanced as much as possible. That is, in the example shown in FIG. 9, migration 422 of the virtual machine B is performed from the second ECU 412 to the first ECU 410. As a result, the free resources of the first ECU 410 decrease to 30% although this does not mean that resources are tight, and free resources increase to 45% in the second ECU 412, enabling operation of the virtual machine C to be stably maintained.

When tightness of the resources in the first ECU 410 or the second ECU 412 cannot be avoided by only performing migration such as the migration 422 shown in FIG. 9, the controller executes processing for reducing resource allocation to the virtual ECUs (resource reduction processing).

Hereinafter, the resource reduction processing will be described. Note that the resource reduction processing affects the performance of the virtual ECU that is targeted. In view of his, restrictions such as the following are provided on the allocation and reduction of resources.
Virtual ECUs having “high” priority: unlimited use of resources; not targeted for resource reduction
Virtual ECUs having “medium” priority: unlimited use of resources; not targeted for resource reduction
Virtual ECUs having “low” priority: use of resources as long there are free resources; targeted for resource reduction when resources are tight

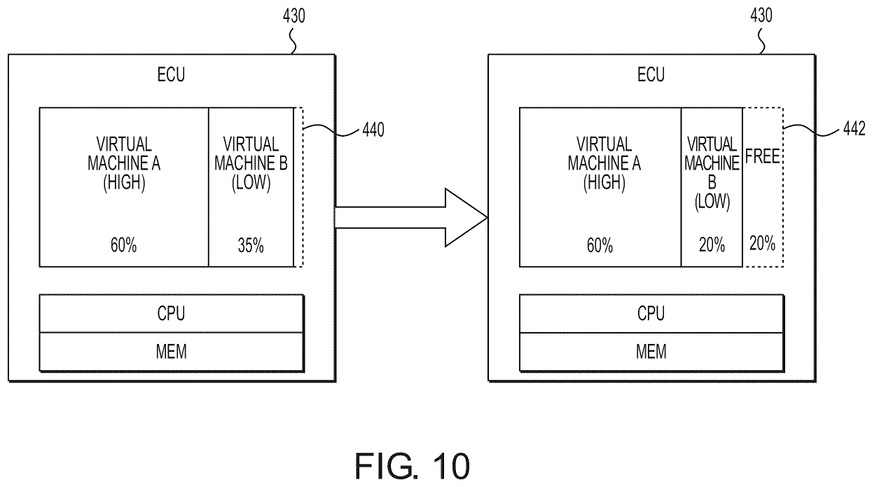

FIG. 10 shows an outline of the resource reduction processing. Referring to the left side of FIG. 10, in an ECU 430, for example, as a result of the resource occupancy rate of a virtual machine A, which has a high priority, becoming high at 60%, free resources 440 decrease to 5%, which is less than or equal to the threshold value, and resource tightness is detected. It is possible for the virtual machine A to request further resources. At this time, there can be cases where a low priority virtual machine B cannot be migrated to another ECU, due to the other ECUs not having sufficient free resources. In such cases, in this embodiment, as shown on the right side of FIG. 10, an attempt is made to eliminate the resource tightness by setting the amount of free resources 442 to greater than or equal to the threshold value (e.g., to 20%), by reducing the resources allocated to the low priority virtual machine B.

As a technique for reducing allocated resources, reduction of the number of allocated cores is given as an example in the case of the CPU. In the case of memory, techniques such as so-called memory ballooning, memory swapping and memory compression are given as examples.

### C. Hardware and Software

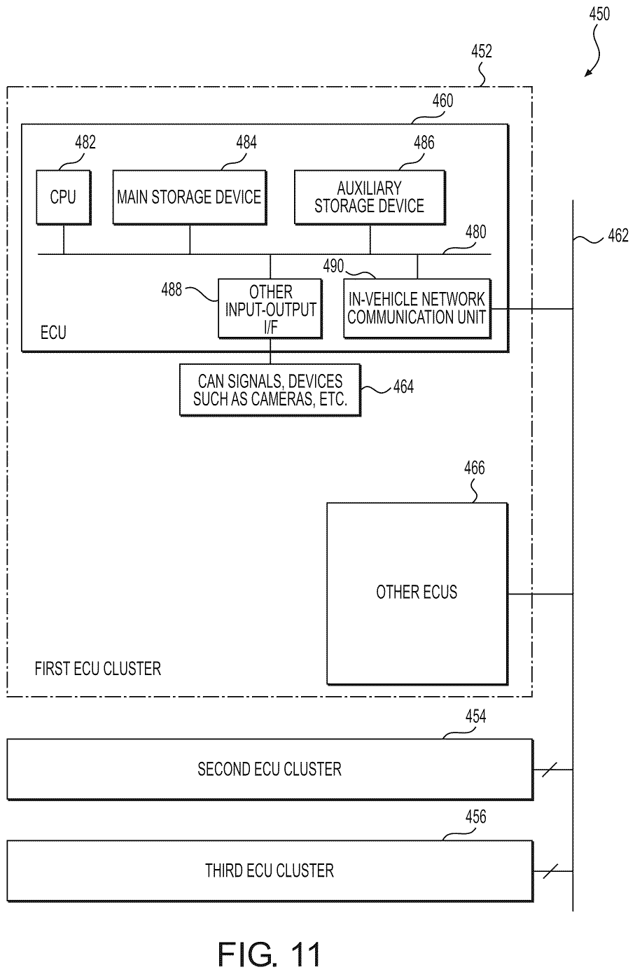

FIG. 11 shows, in block diagram format, a hardware configuration for realizing an in-vehicle system 450 according to this embodiment. Referring to FIG. 11, the in-vehicle system 450 includes an in-vehicle network 462 and a first ECU cluster 452, a second ECU cluster 454, and a third ECU cluster 456 that are all connected to the in-vehicle network 462. These clusters may have specific configurations (number of ECUs, number of virtual machines, etc.) that differ from each other, but the basic configurations are alike. Accordingly, the configuration and operations of the first ECU cluster 452 will be described below.

The first ECU cluster 452 includes an ECU 460 connected to the in-vehicle network 462 and one or more ECUs 466 connected to the in-vehicle network 462. In this embodiment, the ECU 460 and the plurality of ECUs 466 are ECUs of the same standard. The ECU 460 can also be used as an ECU for providing a virtual platform or as a controller ECU. In the following description, the ECU 460 is a controller ECU, and virtual ECUs operate in the plurality of ECUs 466.

The ECU 460 is substantively a computer, and includes a CPU 482, a main storage device 484, an auxiliary storage device 486, an input-output I/F (interface) 488, an in-vehicle network communication unit 490, and a bus 480 that connects all these constituent elements in such a manner as to be capable of communicating with each other. Signals from various devices 464 such as cameras, for example, CAN (Controller Area Network) signals, and the like are input to the input-output I/F 488. The in-vehicle network communication unit 490 is the interface with the in-vehicle network 462 for the ECU 460. The ECU 460 is capable of communicating with all the other ECUs belonging to the plurality of ECUs 466 via the in-vehicle network communication unit 490 and the in-vehicle network 462.

Programs that are executed by the CPU 482 are stored in the auxiliary storage device 486. When executing a program, the CPU 482 reads out the program from a designated address in the auxiliary storage device 486. The CPU 482 loads the program into the main storage device 484, reads out an instruction from the designated address, and executes the instruction. The CPU 482 decodes the instruction that was read out. As a result of the decoding, the CPU 482 reads out data from an address designated by the instruction, performs a computational operation designated by the decoding result, and stores the result of the computational operation in the address designated by the instruction. The CPU 482 has a program counter not shown and updates the contents of the program counter in accordance with the result of executing the instruction. The CPU 482 reads out a new instruction from an address in the main storage device 484 designated by the updated program counter and executes the new instruction. By executing such processing, the CPU 482 realizes a function defined by the program.

Note that, in this embodiment, the CPU 482 is assumed to have multiple cores and to also be capable of executing speculative instructions. As a result, various processing can be executed at high speed.

The virtual ECUs are, in substance, files installed in the auxiliary storage device 486. A virtualization program likewise installed in the auxiliary storage device 486 is loaded into the main storage device 484 and executed by the CPU 482. The virtualization program realizes the virtual ECUs by reading out the files of the virtual ECUs and emulating a CPU in accordance with the contents of the files. Specifically, as the virtualization program, it is desirable to use a type of program called a hypervisor that bypasses the host OS and provides direct access to the hardware resources of the computer. The virtualization program is, of course, not limited to a hypervisor, and a virtualization program that operates on the host OS may also be used.

Hereinafter, the control structure of the program that realizes the functions of the controller in this embodiment will be described. Here, the controller, as shown in FIG. 5, is an application that operates, not in a virtualized environment, but on the host CPU in the controller ECU 326, which is a dedicated computer. This program is started as a result of the controller ECU 326 being started and the program of the controller (hereinafter, “controller program”) being loaded into memory in the startup sequence. This program repeatedly executes processing described below and performs real-time detection and execution of a processing request of some sort (migration request, resource reduction request, etc.) relating to maintaining the virtual machines. The real-time execution referred to here is so-called real-time processing in information processing technologies. Real-time processing is a concept contrasted with batch processing and refers to performing processing immediately when a processing request of some sort occurs.

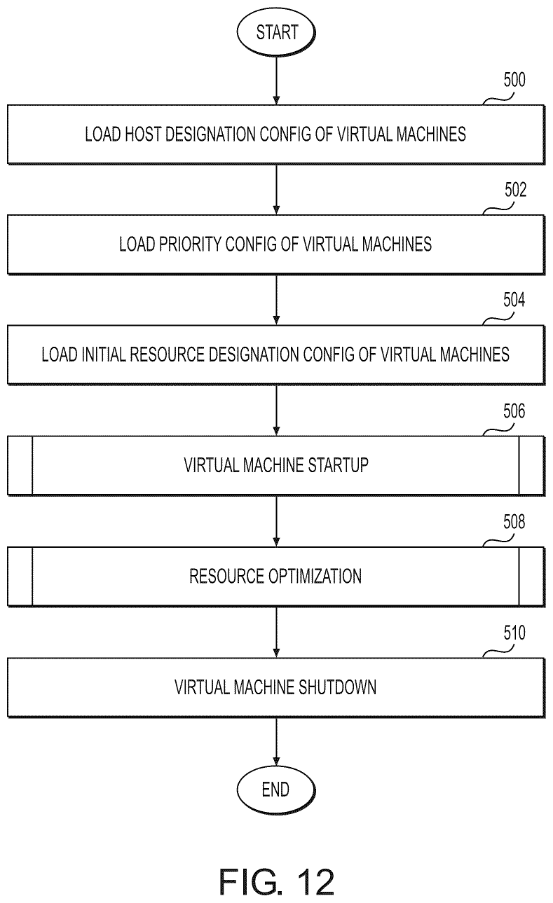

Referring to FIG. 12, the controller program includes step 500 of loading the host designation config 370 (FIG. 6) of the virtual ECUs, step 502 of loading the priority config 372 (FIG. 7) of the virtual ECUs, and step 504 of loading the initial resource designation config 374 (FIG. 8) of the virtual ECUs, at a timing such as after securing and initializing the storage area immediately following startup or after initializing various control variables. The controller program stores the information read out from these config files in variables within the program.

This program further includes step 506 of starting all virtual ECUs, after step 504. In order to start all the virtual ECUs, the information loaded in steps 500, 502 and 504 described above is required.

This program further includes step 508 of optimizing the resources allocated to the virtual ECUs, following step 506. Step 508 is repeatedly executed while the in-vehicle system is operating.

This program further includes step 510 of shutting down all virtual ECUs and ending execution of the controller program, after the in-vehicle system is instructed to stop and the processing of step 508 has ended.

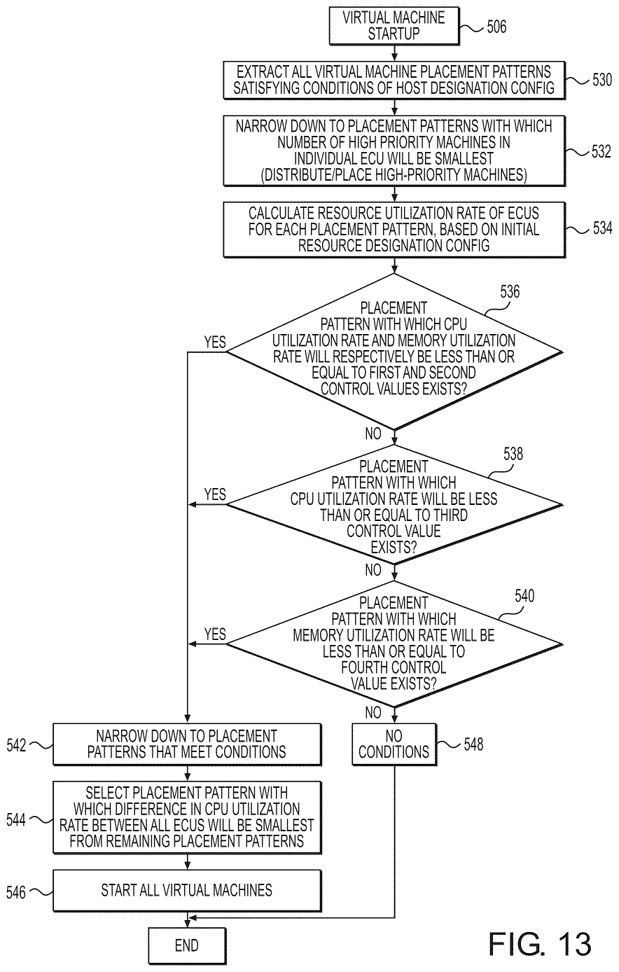

Referring to FIG. 13, step 506 of starting the virtual ECUs includes step 530 of extracting all the placement patterns of the virtual ECUs designated by the host designation config 370, and step 532 of narrowing down the placement patterns extracted in step 530 to placement patterns with which the number of high priority machines placed in individual ECUs will be smallest.

This program further includes step 534 of calculating the resource utilization rate of the ECUs, for each of the placement patterns remaining in step 532, based on the contents of the initial resource designation config 374. As aforementioned, the resource utilization rate referred to here is a concept that combines the CPU utilization rate and the memory utilization rate. This program further includes step 536 of branching the flow of control according to whether or not there is a placement pattern with which both the CPU utilization rate and memory utilization rate calculated in step 534 will be less than or equal to respective control values. The control values here refer to both a first control value, which is the control value of the CPU utilization rate, and a second control value, which is the control value of the memory utilization rate. These two types of control values need not be the same. Note that a plurality of types of control values appear in the following description, and these values may respectively be the same as or may be different from the above control values.

This program further includes step 538 of branching the flow of control according to whether or not there is a placement pattern with which the CPU utilization rate will be less than or equal to a third control value, when the determination in step 536 is negative, and step 540 of branching the flow of control according to whether or not there is a placement pattern with which the memory utilization rate will be less than or equal to a fourth control value, when the determination of step 538 is negative. In this embodiment, the third control value is the same as the first control value in step 536. However, these two values need not be the same. For example, the third control value may be less than or equal to the first control value. Similarly, in this embodiment, the fourth control value is the same as the second control value, but these values need not be the same. For example, the fourth control value may be less than or equal to the second control value.

This program includes step 542 of narrowing down the placement patterns to placement patterns that meet the conditions designated in step 536, 538 or 540, when the determination in these steps is positive, and step 544 of selecting a placement pattern with which the difference in CPU utilization rate between all the ECUs will be smallest, from the placement patterns remaining in step 542. This program further includes step 546 of distributing the virtual ECUs to each ECU in accordance with the placement pattern selected in step 544 and starting all the virtual ECUs, and then ending step 506.

If the determination of step 540 is negative, processing in the case where a suitable placement for the virtual ECUs is not found is executed in step 548. In step 548, it is conceivable to, for example, change the config file so as to not start low priority virtual ECUs and execute step 506 again. Alternatively, it is also possible to uniformly reduce the resources allocated to low priority virtual ECUs and execute step 506 again. In some cases, display indicating that the virtual ECUs cannot be started may be performed and a user instruction may be accepted.

Note that the range (difference between maximum and minimum values), average deviation, or variance of the CPU utilization rates of the placement patterns after calculating the CPU utilization rate of each placement pattern of all the ECUs may be used as the “difference” referred to in “the placement pattern with which the difference in CPU utilization rate between all the ECUs will be smallest” in step 544.

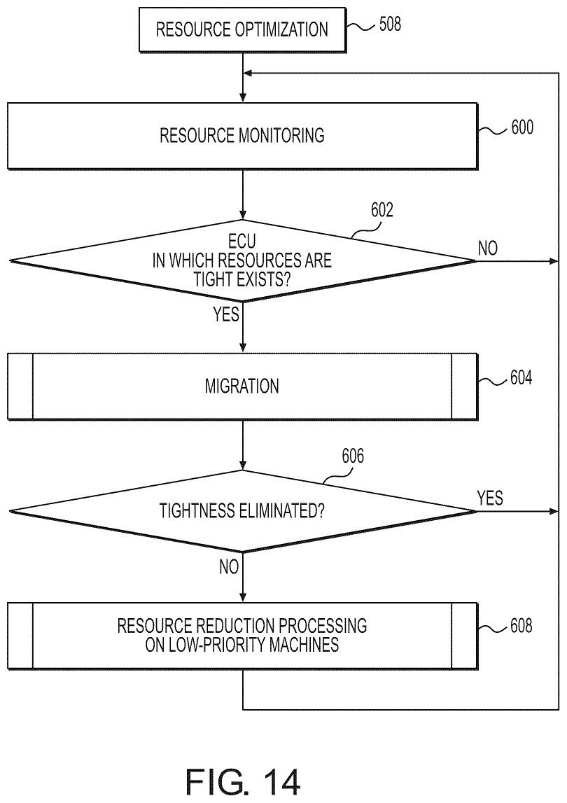

Referring to FIG. 14, step 508 of FIG. 12 includes step 600 of monitoring the resource utilization rate of each ECU and step 602 of branching the flow of control according to whether or not there is an ECU in which resources are tight, based on the result of the monitoring in step 600. The determination in step 602 will be positive when the CPU utilization rate exceeds the control value or the memory utilization rate exceeds the control value in a certain ECU, for example. If the determination in step 602 is negative, control returns to step 600 and resource monitoring is executed again.

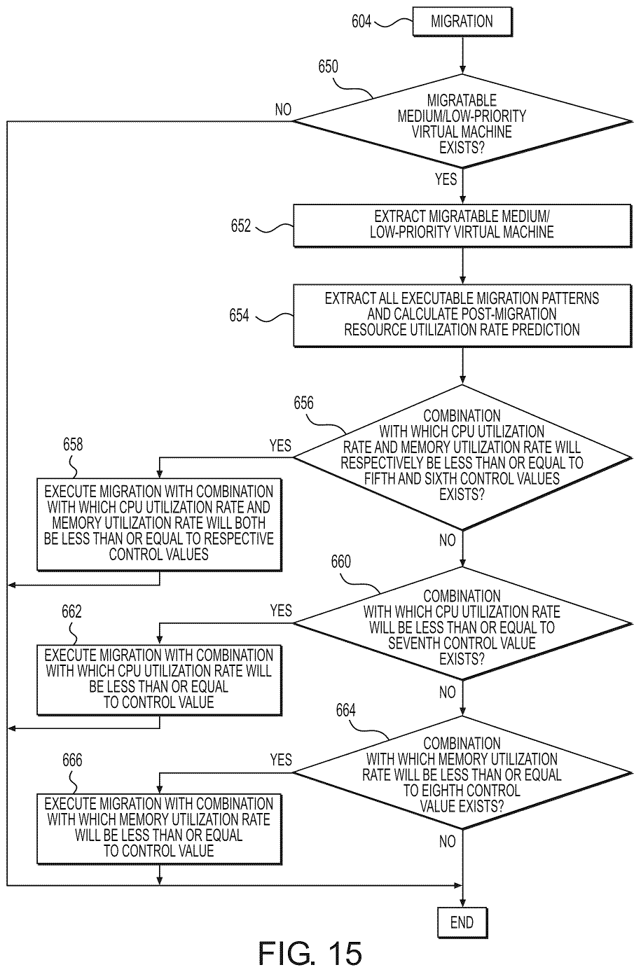

This program further includes step 604 of migrating one of the virtual ECUs operating in the ECU determined to be resource tight to another ECU, when the determination in step 602 is positive. The contents of the processing of step 604 will be described later with reference to FIG. 15.

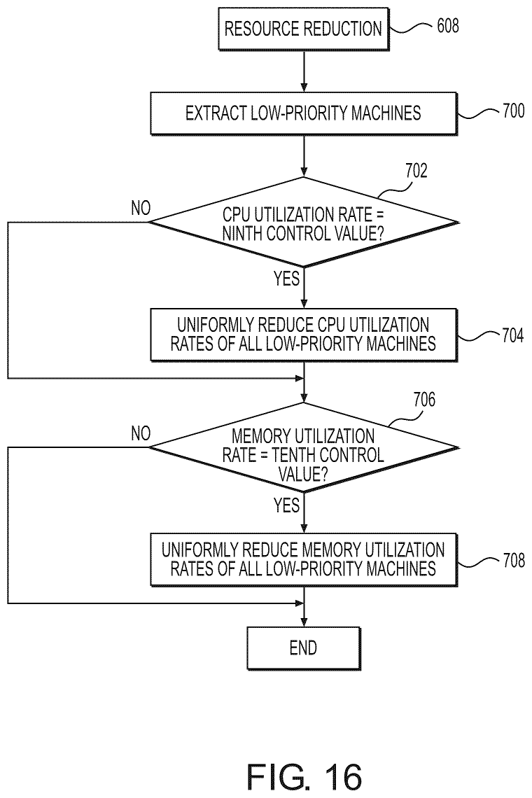

This program further includes step 606 of branching the flow of control according to whether or not the resource tightness has been eliminated, after step 604. The determination in step 606 is performed according to whether or not the resource utilization rate is less than or equal to the control value in all ECUs of the in-vehicle system. If the determination in step 606 is positive, control returns to step 600 and resource monitoring is resumed. This program further includes step 608 that is executed in response to the determination in step 606 being negative and is a step of reducing the resources of low priority machines. Thereafter, control returns to step 600. The contents of step 608 will be described later with reference to FIG. 16. In this way, in this embodiment, the controller constantly monitors whether resource tightness has occurred by comparing various indicators with control values. If the result of the comparison between the indicators and the control values indicates that resource tightness has occurred, the controller determines that the tightness needs to be eliminated and immediately executes processing for that purpose.

The control structure of the program that executes the migration in step 604 will now be described with reference to FIG. 15. Step 604 includes step 650 of branching the flow of control according to whether or not there are medium/low priority virtual ECUs operating in the ECU in which resources are tight. If the determination in step 650 is negative, execution of step 604 is ended.

Step 604 further includes step 652 of extracting the migratable virtual ECU, when the determination in step 650 is positive, and step 654 of extracting all executable migration patterns for the virtual ECUs extracted in step 652 and calculating a prediction of the post-migration resource utilization rate for each pattern.

Step 604 further includes step 656 of branching the flow of control according to whether or not there is a combination with which both the CPU utilization rate and the memory utilization rate will be less than or equal to the respective control values, based on the result of the processing in step 654, and step 658 of executing migration of the target virtual ECU so as to realize the combination found in step 656 and ending step 604, when the determination in step 656 is positive. Note that the control value of the CPU utilization rate in step 656 is a fifth control value, and the control value of the memory utilization rate is a sixth control value.

Step 604 further includes step 660 of branching the flow of control according to whether or not there is a combination with which the CPU utilization rate will be less than or equal to a seventh control value, when the determination of step 656 is negative, and step 662 of executing migration of the target virtual ECU, so as to realize the combination found in step 660, and ending step 604, when the determination in step 660 is positive.

Step 604 further includes step 664 of branching the flow of control according to whether or not there is a combination with which the memory utilization rate will be less than or equal to an eighth control value, when the determination in step 660 is negative, and step 666 of executing migration of the target virtual ECU, so as to realize the combination found in step 664, and ending step 604, when the determination in step 664 is positive. If the determination in step 664 is negative, step 604 is ended without performing migration.

If there are a plurality of possible combinations in steps 656, 660, or 664, a combination need only be selected using similar criteria to step 544 in FIG. 13.

Referring to FIG. 16, step 608 in FIG. 14 includes step 700 of extracting all low priority machines operating in the ECU (target ECU) in which resource tightness is detected, step 702 of branching the flow of control according to whether or not the CPU utilization rate of the target ECU is greater than or equal to a ninth control value, and step 704 of uniformly reducing the CPU utilization rate of all low priority machines operating in the target ECU by a certain amount, when the determination in step 702 is positive. When the determination in step 702 is negative, control proceeds to step 706.

Step 608 further includes step 706 of branching the flow of control according to whether or not the memory utilization rate in the target ECU is greater than or equal to a tenth control value, after step 704, and step 708 of uniformly reducing the memory utilization rate of all low-priority machines in the target ECU by a certain percentage (or a certain amount) and ending execution of step 608, when the determination in step 706 is positive. When the determination in step 706 is negative, execution of step 608 is ended.

### 2. Operations

The first ECU cluster 452 (FIG. 11) having the configuration described above operates as follows.

### A. at Startup

Referring to FIG. 11, when the in-vehicle system 450 is powered on, the ECU 460 and the plurality of ECUs 466 of the first ECU cluster 452 are started. Each of the plurality of ECUs 466 starts a hypervisor and waits for an instruction to start the virtual ECUs.

The ECU 460 operating as a controller ECU operates as follows. Note that the host designation config 370, the priority config 372, and the initial resource designation config 374 are all assumed to be stored in the auxiliary storage device 486.

Referring to FIG. 12, the ECU 460 reads out the host designation config 370, the priority config 372, and the initial resource designation config 374 from the auxiliary storage device 486 (steps 500, 502, and 504), and substitutes designated values into predetermined variables of the program.

Referring to FIG. 13, the ECU 460 calculates the resource utilization rate, for each of the possible placement patterns of the virtual ECUs, by executing steps 530, 532, and 534. Furthermore, if there are placement patterns of the virtual ECUs that meet the conditions designated in step 536, 538, or 540, the placement patterns of the virtual ECUs are narrowed down to those placement patterns in step 542. Furthermore, in step 544, the ECU 460 calculates, for each of the remaining placement patterns, the CPU utilization rate of each ECU that hosts virtual ECUs within the first ECU cluster 452. Furthermore, the ECU 460 selects, from the placement patterns, a placement pattern with the smallest difference in CPU utilization rate between the ECUs. In step 546, the ECU 460 distributes the virtual ECUs to the respective ECUs in accordance with the selected placement pattern and starts the virtual ECUs, and then ends the processing of step 506.

### B. Monitoring and Resource Coordination

Returning to FIG. 12, the ECU 460 starts the resource optimization processing of step 508. Referring to FIG. 14, the ECU 460 monitors the resources of each ECU. Specifically, the ECU 460 calculates the CPU utilization rate and the memory utilization rate of each ECU.

In step 602, the ECU 460 determines whether there is an ECU in which resources are tight. When no such ECU exists, control returns to step 600 and the ECU 460 resumes resource monitoring. When there is an ECU in which resources are tight, the ECU 460, in step 604, executes the migration processing shown in FIG. 15.

Referring to FIG. 15, in the migration processing of step 604, the ECU 460 selects migratable medium/low priority machines operating in the ECU (target ECU) in which resource tightness was detected in step 602 of FIG. 14. The ECU 460, in step 654, further extracts all executable migration patterns for the medium/low priority machines extracted in step 652. The ECU 460, in step 654, further calculates the post-migration resource utilization rate for each of the extracted migration patterns. Executable migration is executed in steps 656, 658, 660, 662, 664 and 666, based on this resource utilization prediction. If the resource tightness will not be eliminated according to the resource utilization prediction even if migration is performed, the determinations in steps 656, 660, and 664 will all be negative, and migration is not executed.

Referring again to FIG. 14, if the resource tightness is eliminated as a result of executing step 604, the determination of step 606 will be positive and the resource optimization processing is ended. Step 608 is executed if the resource tightness is not eliminated.

Referring to FIG. 16, in step 608, if the CPU utilization rate is greater than or equal to the ninth control value in the ECU in which resource tightness was detected (determination in step 702 is positive), the CPU utilization rates of all the low priority machines operating on that ECU are uniformly reduced (step 704). Furthermore, if the memory utilization rate in that ECU is greater than or equal to the tenth control value (determination in step 706 is positive), the memory utilization rates of all the low priority machines operating on that ECU are reduced.

If the determination in step 702 is negative, the resource reduction processing is not executed in step 608. If the determination in step 702 is positive and the determination in step 706 is negative, the CPU utilization rates of the low priority machines are reduced but the memory utilization rates are not reduced.

As described above, according to this embodiment, an ECU cluster is constituted by a plurality of ECUs, and a controller manages virtual ECUs that are executed in each ECU. In this management, when resources in an ECU become tight, the controller eliminates the resource tightness in the ECU by migrating a virtual ECU from that ECU to another ECU. When the resource tightness is not eliminated even after performing migration, the controller reduces the resources of low priority virtual ECUs operating in that ECU. Those resources can thereby be utilized by other higher priority machines operating in that ECU. As a result of the controller performing such management, the load on the ECUs is dynamically redistributed, and the functions of the in-vehicle system are maintained.

### First Variation

The above embodiment is premised on there being one ECU cluster in the in-vehicle system. However, this disclosure is not limited to such an embodiment. The in-vehicle system may have a plurality of ECU clusters. In this case, each ECU cluster has a controller, and the controllers perform dynamic redistribution of the load on the respective ECU clusters independently. As a result, dynamic redistribution of the load can be easily performed, even though there is an increase in the overall size of the in-vehicle system and the number of ECUs.

Also, in the above embodiment, information relating to the virtual ECUs in each ECU is synchronized between the ECUs. However, this disclosure is not limited to such an embodiment. Such synchronization may be performed immediately before migration rather than being performed all the time.

In the above embodiment, placement configuration information relating to the virtual ECUs is contained in three config files. However, this disclosure is not limited to such an embodiment. The placement configuration information may be contained in one config file or may be contained in two config files or four or more config files. Also, the placement configuration information relating to the virtual ECUs need not be contained in a file. The placement configuration information may be stored in a database, for example. This database may be provided for each ECU cluster or only one database may be provided for the entire in-vehicle system. In the case where only one database is provided for the entire in-vehicle system, an identifier needs to be assigned to each ECU cluster and fields of the identifiers need to be provided in respective records of the database. Also, in a source program of the controller program, placement configuration information relating to these virtual ECUs may be described collectively as literals. Although the need to compile the controller program arises in this case, the contents of the placement configuration information can be easily changed. Furthermore, for each ECU cluster, for example, a program that, when called, returns the placement configuration information of the ECU cluster or a pointer indicating the storage address thereof as a return value in a certain format may be created separately from the controller program. In this case, it will not be necessary to recompile the controller program.

In the above embodiment, the config files contain placement configuration information for the name or identifier of each specific virtual ECU. However, this disclosure is not limited to such an embodiment. For example, predetermined classes may be defined in advance for the priorities or initial secured resources of the virtual machines, or for combinations thereof. In this case, the priorities, initial secured resources, or combinations thereof need only be designated by the class name or class identifier thereof.

The embodiments disclosed herein are to be considered in all respects as illustrative and not restrictive. The scope of the present disclosure is indicated by the individual claims rather than by the detailed description of the disclosure, and all changes that come within the meaning and range of equivalency of the wording of the claims are intended to be embraced therein.

1. An in-vehicle system comprising:
an information processing apparatus cluster that includes a first processor and a second processor that are capable of communicating with each other,
wherein the first processor and the second processor each include:
computer hardware; and
a virtualization platform configured to operate on the computer hardware; and
a controller configured to operate one or more virtual machines on the virtualization platform of each of the first processor and the second processor,
wherein the controller monitors a usage situation of hardware resources in the first processor and the second processor, and changes a configuration of the one or more virtual machines in real time according to the usage situation of the hardware resources.

2. The in-vehicle system according to claim 1,
wherein the controller includes a controller device provided independently of the first processor and the second processor that are included in the information processing apparatus cluster, and the controller device is capable of communicating with the first processor and the second processor.

3. The in-vehicle system according to claim 1,
wherein the controller includes a virtual controller configured to be executed on the virtualization platform of the first processor.

4. The in-vehicle system according to claim 1,
wherein the controller is configured to:
record placement configuration information defining a placement configuration of the one or more virtual machines; and
monitor an operation situation of the first processor and the second processor, determine placement of the one or more virtual machines in the information processing apparatus cluster in real time such that the one or more virtual machines operate stably, and change the placement of the one or more virtual machines.

5. The in-vehicle system according to claim 4,
wherein the placement configuration information includes:
host designation information recording a virtual machine, among the one or more virtual machines, to be operated in a specific processor that is a host, and information designating the specific processor that is the host,
priority information designating priorities relating to the one or more virtual machines and for use when allocating the hardware resources,
initial resource information designating an initial allocation of the hardware resources when starting the one or more virtual machines, or
at least two of the host designation information, the priority information, and the initial resource information.

6. The in-vehicle system according to claim 4, wherein:
the placement configuration information includes:
host designation information recording a virtual machine, among the one or more virtual machines, to be operated in a specific processor that is a host, and information designating the specific processor that is the host, and
priority information designating priorities relating to the one or more virtual machines and for use when allocating the hardware resources,
the priorities include a first priority that is highest and a second priority that is lower than the first priority, and
the controller is configured to monitor the usage situation of the hardware resources in the first processor, and, in response to tightness of the hardware resources being detected in the first processor, select a virtual machine that is shown by the host designation information as being movable to the second processor and whose priority is the second priority, among virtual machines being executed in the first processor, and move the selected virtual machine to the second processor.

7. The in-vehicle system according to claim 6,
wherein the processor is configured to monitor the usage situation of the hardware resources in the first processor and the second processor, and, in response to tightness of hardware resources in the in-vehicle system being detected even after movement of a virtual machine by the controller, reduce allocation of the hardware resources to a virtual machine whose priority is the second priority, among virtual machines operating in the first processor and the second processor in which tightness of the hardware resources is detected.

8. The in-vehicle system according to claim 1, comprising a plurality of information processing apparatus clusters including the information processing apparatus cluster.

9. A control method of an in-vehicle system that includes an information processing apparatus cluster that includes a first processor and a second processor that are capable of communicating with each other,
the first processor and the second processor each including:
computer hardware; and
a virtualization platform configured to operate on the computer hardware,
the control method comprising:
operating, with a computer, one or more virtual machines on the virtualization platform of each of the first processor and the second processor;
monitoring, with the computer, a usage situation of hardware resources in the first processor and the second processor; and
changing a configuration of the one or more virtual machines in real time, in response to tightness of hardware resources being detected in the first processor.

10. The in-vehicle system according to claim 2,
wherein the controller is configured to:
record placement configuration information defining a placement configuration of the one or more virtual machines; and
monitor an operation situation of the first processor and the second processor, determine placement of the one or more virtual machines in the information processing apparatus cluster in real time such that the one or more virtual machines operate stably, and change the placement of the one or more virtual machines.

11. The in-vehicle system according to claim 3,
wherein the controller is configured to:
record placement configuration information defining a placement configuration of the one or more virtual machines; and
monitor an operation situation of the first processor and the second processor, determine placement of the one or more virtual machines in the information processing apparatus cluster in real time such that the one or more virtual machines operate stably, and change the placement of the one or more virtual machines.

12. The in-vehicle system according to claim 2, comprising a plurality of information processing apparatus clusters including the information processing apparatus cluster.

13. The in-vehicle system according to claim 3, comprising a plurality of information processing apparatus clusters including the information processing apparatus cluster.

14. The in-vehicle system according to claim 4, comprising a plurality of information processing apparatus clusters including the information processing apparatus cluster.

15. The in-vehicle system according to claim 5, comprising a plurality of information processing apparatus clusters including the information processing apparatus cluster.

16. The in-vehicle system according to claim 6, comprising a plurality of information processing apparatus clusters including the information processing apparatus cluster.

17. The in-vehicle system according to claim 7, comprising a plurality of information processing apparatus clusters including the information processing apparatus cluster.
